(19) United States
(12) Patent Application Publication
(10) Pub. No.: US 2024/0312750 A1
(43) Pub. Date: Sep. 19, 2024

(54) Relay

(71) Applicant: SANYOU CORPORATION LIMITED, Dongguan (CN)

(72) Inventors: Rongai Yu, Dongguan (CN); Junping Tang, Dongguan (CN); Bingqi Chen, Dongguan (CN); Yichao Kuang, Dongguan (CN); Zuhao Ye, Dongguan (CN)

(21) Appl. No.: 18/676,536

(22) Filed: May 29, 2024

Related U.S. Application Data
(63) Continuation of application No. PCT/CN2021/143465, filed on Dec. 31, 2021.

(30) Foreign Application Priority Data
Dec. 7, 2021 (CN) 202111486449.X

(51) Int. Cl. H01H 50/64; H01H 50/54

(52) U.S. Cl. CPC H01H 50/645; H01H 50/54

(57) ABSTRACT

Disclosed in the present disclosure is a relay, relating to the technical field of switch devices, including a fixed base, a stationary contact, a movable contact plate, a push rod, an electromagnetic assembly, a reset elastic member, an elastic assembly, a first magnetically guiding sheet, and a second magnetically guiding sheet; the first magnetically guiding sheet is provided on a side of the movable contact plate facing the stationary contact, the second magnetically guiding sheet is provided on a side of the movable contact plate away from the stationary contact, both the first magnetically guiding sheet and the second magnetically guiding sheet can be magnetized by a current passing through the movable contact plate, the second magnetically guiding sheet and the first magnetically guiding sheet can form a closed magnetic loop.

### CROSS REFERENCE TO RELATED APPLICATIONS

The present application is a Continuation Application of PCT Application No. PCT/CN2021/143465 filed on Dec. 31, 2021, which claims the benefit of Chinese Patent Application No. 202111486449.X filed on Dec. 7, 2021. All the above are hereby incorporated by reference in their entirety.

### FIELD

The present disclosure relates to the technical field of switch devices and, particularly, to a relay.

### BACKGROUND

With the rapid development of the new energy industry, the requirements for fault short-circuit current in vehicle manufacturers and battery pack manufacturers are getting increasingly high. On the basis of maintaining the characteristics of compact size and low coil power, the relay is required to have the function of short-circuit resistance, which may resist the electric repulsion of the movable spring when the system suffers a fault of high current.

At present, the market requirements of the typical input of the short-circuit resistance is required to achieve that the circuit will not burn or explode at 8000 A in 5 ms. However, the relay of the prior art is not able to provide sufficient contact pressure while keeping the characteristics of compact size and low coil power, so that an electric repulsion is generated between the movable contact and the stationary contact when there is a faulty short-circuit current. If the contact pressure is insufficient to resist the electric repulsion of the movable spring, the movable spring and the stationary spring are bounced apart, which affects the stability of the contact between the movable contact and the stationary contact, making it difficult to satisfy the market requirements.

### SUMMARY

To overcome at least one of the aforementioned deficiencies of the prior art, provided in the present disclosure is a relay, which optimizes the existing relay that suffers from poor stability due to the generation of electric repulsion.

The technical solutions adopted by the present disclosure to solve the problems are as follows.

In accordance with an aspect of the present disclosure, provided in the present disclosure is a relay, including: a fixed base; a stationary contact, fixed with respect to the fixed base; a movable contact plate, provided with a movable contact corresponding to the stationary contact; a push rod, slidable with respect to the fixed base, the movable contact plate being movably provided, in a direction parallel to a sliding direction of the push rod, with respect to the push rod; an electromagnetic assembly, used to driving the push rod to slide; a reset elastic member, used to provide an elastic force for disengagement of the movable contact from the stationary contact; at least one set of elastic assemblies, whose elastic force acts on the push rod and the movable contact plate, the elastic assembly comprising at least two elastic members; a first magnetically guiding sheet; and a second magnetically guiding sheet, in which the first magnetically guiding sheet is provided on a side of the movable contact plate facing the stationary contact, the second magnetically guiding sheet is provided on a side of the movable contact plate away from the stationary contact, both the first magnetically guiding sheet and the second magnetically guiding sheet are able to be magnetized by a current passing through the movable contact plate, the second magnetically guiding sheet and the first magnetically guiding sheet are able to form a closed magnetic loop, the electromagnetic assembly drives the push rod to slide, and, after the push rod drives the movable contact plate to move so as to close the movable contact and the stationary contact by means of at least one of the elastic members, an elastic force of the remaining elastic members acts on the movable contact plate to increase a pressing force between the movable contact and the stationary contact, as the push rod continues to slide.

In such an arrangement, when closing the movable contact plate and the stationary contact, the current may flow from an end of the movable contact plate to an opposite end thereof. Since the first magnetically guiding sheet and the second magnetically guiding sheet close to each other and form a closed magnetic loop, when the current flows through the movable contact plate, with the current change forming a closed magnetic loop between the first magnetically guiding sheet and the second magnetically guiding sheet, there presents an electromagnetic attraction force between the first magnetically guiding sheet and the second magnetically guiding sheet, and the electromagnetic attraction force may offset a part of the electric repulsion generating by the great current flowing through the stationary contact and the movable contact of the movable contact plate.

Additionally, when closing the movable contact and the stationary contact, the electromagnetic assembly drives the push rod to overcome the elastic force of the reset elastic member to move, so that the push rod drives the movable contact plate to move in a direction close to the stationary contact, and the movable contact of the movable contact plate is abutted against the stationary contact to achieve the closing. To ensure the tightness and the reliability of the closing of the movable contact and the stationary contact, after the movable contact and the stationary contact are abutted and closed, the electromagnetic assembly continues to drive the push rod to move forward, and the stationary contact is abutted against the movable contact plate via the movable contact, so that the movable contact plate moves with respect to the push rod in an opposite direction to the movement of the push rod, allowing each elastic member of the elastic assembly successively to generate an elastic force in an opposite direction, and the reverse elastic force that the elastic assembly applies to the movable contact plate is gradually increased. The reason for such an arrangement is that the elastic force generating by the elastic assembly applies to both the movable contact plate and the push rod, so that it provides an elastic pressing force to keep the movable contact plate to be abutted against the stationary contact, and also causes an obstruction to the movement of the push rod. When driving the movable contact plate to move towards the stationary contact, the changing rate of the driving force provided by the electromagnetic assembly is different. Specifically, before the movable contact is abutted against the stationary contact and a short period time after the movable contact is abutted against the stationary contact, the driving force and the changing rate of the electromagnetic assembly are relatively low. If the reverse elastic force generating by the elastic assembly is too great, the driving force of the electromagnetic assembly may be insufficient, so that the armature and the stationary iron core in the electromagnetic assembly is unable to close, which leads to a poor stability, causing easy detachment of the contacts. When the armature and the stationary iron core in the electromagnetic assembly are gradually approaching closure, the driving force of the electromagnetic assembly increases and the increasing rate of the driving force is relatively great, and at this moment, the driving pushing force generated by the electromagnetic assembly is able to resist a greater reverse elasticity force. Therefore, the elastic force of at least two elastic members of the elastic assembly is stacked to provide a greater reverse elastic force for the movable contact plate, so that the movable contact and the static contact on the movable contact plate are kept tightly against each other even if the relay is passing through a relatively great short-circuit current and generating a relatively great electric repulsion. At this moment, the reverse elastic force generated by the elastic assembly is able to resist such an anomalous movement, and the electromagnetic force of interaction generated between the first magnetically guiding sheet and the second magnetically guiding sheet further maintains the stability of the contact between the movable contact and the stationary contact. Additionally, since the elastic assembly is capable of providing an adapted reverse elastic force in response to changes in the electromagnetic attraction force of the electromagnetic assembly, it facilitates the realization of improved stability of the relay operation while maintaining a small size and a low coil power to satisfy the needs in the actual application process.

Further, a side of the first magnetically guiding sheet facing the second magnetically guiding sheet is provided with a first magnetic attraction surface, a side of the second magnetically guiding sheet facing the first magnetically guiding sheet is provided with a second magnetic attraction surface, and the first magnetic attraction surface and the second magnetic attraction surface are provided facing each other.

In such an arrangement, in the case that the first magnetically guiding sheet and the second magnetically guiding sheet are close to each other, and in the case that a current is passed through the movable contact plate, the movable contact plate magnetizes the first magnetically guiding sheet and the second magnetically guiding sheet so that magnetic poles having opposite magnetic and mutual attraction are generated on the first magnetic attraction surface and the second magnetic attraction surface. Thus, under the action of this electromagnetic force, an attraction force is generated between the first magnetically guiding sheet and the second magnetically guiding sheet, causing them to approach each other, so as to enable to offset a part of the electric repulsion generated due to the great current flowing through the stationary contact and the movable contact of the movable contact plate.

Further, one of the first magnetically guiding sheet and the second magnetically guiding sheet is provided with a sliding protrusion, and the other one is provided with a sliding slot for the sliding protrusion to slide.

In such an arrangement, by setting slide cooperation between the sliding protrusion and the sliding slot, the second magnetically guiding sheet slides stably with respect to the first magnetically guiding sheet, thereby preventing the occurrence of shifting.

Further, one of the first magnetically guiding sheet and the second magnetically guiding sheet is of a flat plate shape, the other one is U-shaped.

Further, both the first magnetically guiding sheet and the second magnetically guiding sheet are provided as U-shaped.

Further, both the first magnetically guiding sheet and the second magnetically guiding sheet are provided as L-shaped.

Further, the elastic assembly includes a first elastic member and a second elastic member, both the first elastic member and the second elastic member are compression springs, and both the first elastic member and the second elastic member are provided on a side of the movable contact plate away from the stationary contact.

In such an arrangement, as an implementation, the compression spring is adopted as the elastic member to provide the movable contact plate with an elastic pressing force in an opposite direction to the movement thereof, when the movable contact plate moves in an opposite direction to the movement of the push rod. In such an arrangement, it resists the electric repulsion of the relay due to the great short-circuit current and avoids the disengagement of the movable contact from the stationary contact.

Further, the elastic assembly includes a first elastic member and a second elastic member, both the first elastic member and the second elastic member are tension springs, and both the first elastic member and the second elastic member are provided on a side of the movable contact plate facing the stationary contact.

In such an arrangement, as another implementation, the tension spring is adopted as the elastic member, and the tension spring is connected to the movable contact plate. When the push rod continues to move forward after the movable contact plate is abutted against the stationary contact, the movable contact plate moving with respect to the push rod pulls the tension spring. As the movable contact plate moves, a plurality of the tension springs gradually apply an elastic pulling force to the movable contact plate, so that the elastic pulling force applied to the movable contact plate in the opposite direction to the movement thereof is gradually increased. In such an arrangement, it resists the electric repulsion of the relay due to the great short-circuit current and avoids the disengagement of the movable contact from the stationary contact.

Further, the elastic assembly includes a first elastic member and a second elastic member, the first elastic member is a tension spring, the second elastic member is a compression spring, the first elastic member is provided on a side of the movable contact plate facing the stationary contact, and the second elastic member is provided on a side of the movable contact plate away from the stationary contact.

In such an arrangement, as another implementation, when the push rod continues to move forward after the movable contact plate is abutted against the stationary contact, the first elastic member and the second elastic member positioned on both sides of the movable contact plate successively apply an elastic force to the movable contact plate in a direction facing the stationary contact, which also generates an elastic pressing force between the movable contact plate and the stationary contact, and may resist the electric repulsion of the relay due to the great short-circuit current to maintain the stability of the closing of the contacts.

Further, the movable contact plate is provided with a through slot, the push rod is provided to pass through the through slot, and the movable contact plate slides with respect to the push rod.

In such an arrangement, the movable contact plate may slide relatively along the push rod, and the push rod serves as a sliding guide for the movement of the movable contact plate, avoiding possible misalignments during the movement of the movable contact plate, which is conducive to the reliability of the closing and opening between the movable contact and the stationary contact.

Further, both sides of the movable contact plate are provided with a guiding plate respectively, and two guiding plates are spaced apart to form a guiding channel for the movable contact plate to slide.

In such an arrangement, by providing the guiding plate on both sides of the movable contact plate, a guiding channel is formed for the movable contact plate to slide, so as to provide a sliding guide for the movable contact plate, reducing the possibility of overturning or horizontal rotation of the movable contact plate, which is conducive to the reliability of the closing and opening between the movable contact and the stationary contact.

Further, all elastic members are provided in a nested configuration in the same elastic assembly.

In such an arrangement, all elastic members are provided in a nested configuration in the same elastic assembly, which may reduce the space occupied and contribute to the miniaturization of the product design.

Further, an elastic member of shorter length is sheathed to an exterior of an elastic member of longer length, or an elastic member of longer length is sheathed to an exterior of an elastic member of shorter length.

Further, all elastic members are provided in parallel along a stretching direction in the same elastic assembly.

In such an arrangement, in case of sufficient space, it is also possible to provide the elastic members of the elastic assembly independently in a parallel arrangement.

Further, all elastic members have a same elastic coefficient in the same elastic assembly.

Further, all elastic members have different elastic coefficients in the same elastic assembly.

In such an arrangement, by setting the elasticity coefficients of all elastic members in the same elastic assembly to be different, it is possible to better match the changing process of the driving force of the electromagnetic assembly and ultimately to provide the optimal reverse elastic force to offset the electric repulsion to stabilize the connection between the movable contact and the stationary contact.

Further, an elastic coefficient of the elastic member generating elastic force first is less than that of the elastic member generating elastic force later in the same elastic assembly.

Therefore, when the movable contact plate is abutted against the stationary contact and moves, the elastic member with a smaller elastic coefficient generates a reverse elastic force before the elastic member with a larger coefficient of elasticity in the same elastic assembly. In such an arrangement, it is possible to adapt to a lower driving force that is provided by the electromagnetic assembly when the movable contact and the stationary contact are just in contact, and as the push rod continues to move forward, the elastic coefficient of the elastic member participating in the reverse elastic force is gradually increased, i.e., it is capable of providing a greater reverse elastic force, i.e., it is able to adapt to the process of the subsequent gradual increase of the driving force provided by the electromagnetic assembly. Further, such a setup is better matched to the changing process of the driving force of the electromagnetic assembly and ultimately provides the optimal reverse elastic force to stabilize the connection between the movable contact and the stationary contact by offsetting the electric repulsion.

Further, an elastic coefficient of the elastic member generating elastic force later is less than that of the elastic member generating elastic force first in the same elastic assembly.

Further, one set of the elastic assembly is provided, and the elastic assembly is positioned on the center of the movable contact plate.

In such an arrangement, it may allow balanced force on the movable contact plate, simplify the structure and reduce troublesome assembly by adopting fewer elastic assemblies under the premise of providing sufficient reverse elastic force to resist the electric repulsion.

Further, at least two sets of the elastic assemblies are provided, and the elastic assemblies are provided centrosymmetrically with respect to the movable contact plate.

In such an arrangement, by means of at least two sets of the elastic assemblies, a balanced and sufficient reverse elastic force is provided to the movable contact plate.

Further, the electromagnetic assembly includes a coil support, a coil, a fixed iron core, a yoke, and an armature, the coil is sheathed to an exterior of the fixed iron core, both the fixed iron core and the yoke are fixed to the coil support, the armature is fixedly connected to the push rod, the yoke and the fixed iron core generate a magnetic flux when the coil is energized, and the magnetic flux tends to form a closed magnetic loop to drive the armature to move close to the fixed iron core.

In such an arrangement, when the coil is energized, an electromagnetic flux is generated in the fixed iron core and the yoke, and the magnetic loop formed by the flux tends to close. Then, the armature is attracted to move in the direction close to the iron core, so as to drive the push rod to move in order to achieve the closure of the movable contact and the stationary contact in the relay. When the coil is de-energized, the electromagnetic flux vanishes, so that the push rod is reset by the elastic force of the elastic assembly and the reset elastic member.

In view of the technical solutions mentioned above, the embodiments of the present disclosure provide at least the following advantages and positive effects.

After the movable contact plate and the stationary contact are closed, when the current is passing through the movable contact plate, with the current change forming a closed magnetic loop between the first magnetically guiding sheet and the second magnetically guiding sheet, there presents an electromagnetic attraction force between the first magnetically guiding sheet and the second magnetically guiding sheet to offset a part of the electric repulsion generating by the great current flowing through the stationary contact and the movable contact of the movable contact plate. After the movable contact and the stationary contact are abutted and closed, the electromagnetic assembly continues to drive the push rod to move forward, and the stationary contact is abutted against the movable contact plate via the movable contact, so that the movable contact plate moves with respect to the push rod in an opposite direction to the movement of the push rod, allowing each elastic member of the elastic assembly successively to generate an elastic force. The elastic force generating by the elastic assembly applies to the movable contact plate to allow a pressing force generated between the movable contact plate and the stationary contact, and the elastic force also applies to the push rod, whose direction is opposite to that of the driving force generated by the electromagnetic assembly. The elastic force generated by the elastic assembly is gradually increased to adapt to the change of the electromagnetic assembly and ultimately provides a greater reverse elastic force to resist the electric repulsion, which facilitates the achievement of maintaining the stability of the contact between the movable contact and the stationary contact while keeping the characteristics of small size and low coil power, and improves the stability of the relay operation to meet the needs in the actual application process.

The compression spring may be adopted as the elastic member to provide the movable contact plate with an elastic pressing force to resist the electric repulsion of the relay due to the great short-circuit current and avoids the disengagement of the movable contact from the stationary contact.

The tension spring may be adopted as the elastic member to provide the movable contact plate with an elastic pulling force to resist the electric repulsion of the relay due to the great short-circuit current and avoids the disengagement of the movable contact from the stationary contact.

A combination of both compression spring and tension spring may be adopted as the elastic member to provide the movable contact plate with an elastic force to resist the electric repulsion of the relay due to the great short-circuit current and avoids the disengagement of the movable contact from the stationary contact.

In the same elastic assembly, the elastic coefficients of each elastic member are different, and the elastic coefficients of the elastic members increase sequentially according to the order of the elastic members subjected to compression or tension, which further adapts to the changing process of the driving force of the electromagnetic assembly and ultimately provides the optimal reverse elastic force to offset the electric repulsion to stabilize the connection between the movable contact and the stationary contact, which further facilitates the achievement of the improved stability of relay operation to meet the needs in practical application while maintaining the characteristics of small volume and low coil power.

### BRIEF DESCRIPTION OF THE DRAWINGS

FIG. 1 is a schematic internal structure diagram of the relay in embodiment 1 of the present disclosure when the movable contact and the stationary contact are in a disconnected state;

FIG. 2 is a schematic internal structure diagram of the relay in embodiment 1 of the present disclosure when the movable contact and the stationary contact are in a closed state;

FIG. 3 is a schematic diagram of the combined force of the elastic assembly and the reset elastic member, and the magnetic attraction force of the electromagnetic assembly as a function of the distance between the armature and the stationary iron core;

FIG. 4 is a schematic exploded diagram of the parts mounted on the push rod in embodiment 1 of the present disclosure;

FIG. 5 is a schematic diagram of the embodiment 1 of the present disclosure when the movable contact plate and the stationary contact are closed and a current I is passing through them;

FIG. 6 is a schematic structural diagram of a first magnetically guiding sheet and a second magnetically guiding sheet of a first type in embodiment 1 of the present disclosure;

FIG. 7 is a schematic structural diagram of a first magnetically guiding sheet and a second magnetically guiding sheet of a second type in embodiment 1 of the present disclosure;

FIG. 8 is a schematic diagram of a first configuration of the elastic assembly in embodiment 1 of the present disclosure;

FIG. 9 is a schematic diagram of a second configuration of the elastic assembly in embodiment 1 of the present disclosure;

FIG. 10 is a schematic diagram of the internal structure of the relay in embodiment 2 of the present disclosure;

FIG. 11 is a schematic partial diagram of the internal structure of the relay in embodiment 4 of the present disclosure;

FIG. 12 is a partial side view of the internal structure of the relay of FIG. 11;

FIG. 13 is a schematic perspective diagram of a part of the structure of the relay of FIG. 11;

FIG. 14 is a schematic structural sketch of the elastic assembly in embodiment 5 of the present disclosure;

FIG. 15 is a schematic structural sketch of the elastic assembly in embodiment 6 of the present disclosure.

The meanings of the attached markings are as follows:

1 fixed base; 101 upper cover; 102 bottom holder; 2 stationary contact; 3 movable contact plate; 301 through slot; 4 push rod; 401 first restricting member; 402 second restricting member; 403 main body; 404 sleeve shaft segment; 405 step segment; 5 electromagnetic assembly; 501 coil support; 502 coil; 503 fixed iron core; 504 yoke; 505 armature; 6 reset elastic member; 7 elastic assembly; 701 elastic member; 701a first elastic member; 701b second elastic member; 8 first magnetically guiding sheet; 801 first magnetic attraction surface; 802 connection hole; 9 second magnetically guiding sheet; 901 second magnetic attraction surface; 902 horizontal end; 903 vertical end; 10 sliding protrusion; 11 sliding slot; 12 guiding plate; 1201 guiding channel; 13 fixing plate; 14 restricting plate.

### DETAILED DESCRIPTION OF THE EMBODIMENTS

For a better understanding and implementation, the technical solutions in the embodiments of the present disclosure are clearly and completely described below in conjunction with the attached drawings of the present disclosure.

In the description of the present disclosure, it is to be noted that the terms “up”, “down”, “front”, “back”, “left”, “right”, “vertical”, “horizontal”, “top”, “bottom”, “inside”, “outside” and other orientation or position relationships are based on the orientation or position relationships shown in the attached drawings. It is only intended to facilitate description of the present disclosure and simplify description, but not to indicate or imply that the referred device or element has a specific orientation, or is constructed and operated in a specific orientation. Therefore, they should not be construed as a limitation of the present disclosure.

Unless otherwise defined, all terms including technical and scientific terms used herein have the same meaning as commonly understood by those skilled in the art to which the present disclosure belongs. The terms used herein in the specification of the present disclosure are used only to describe specific embodiments and are not intended as a limitation of the disclosure.

### Embodiment 1

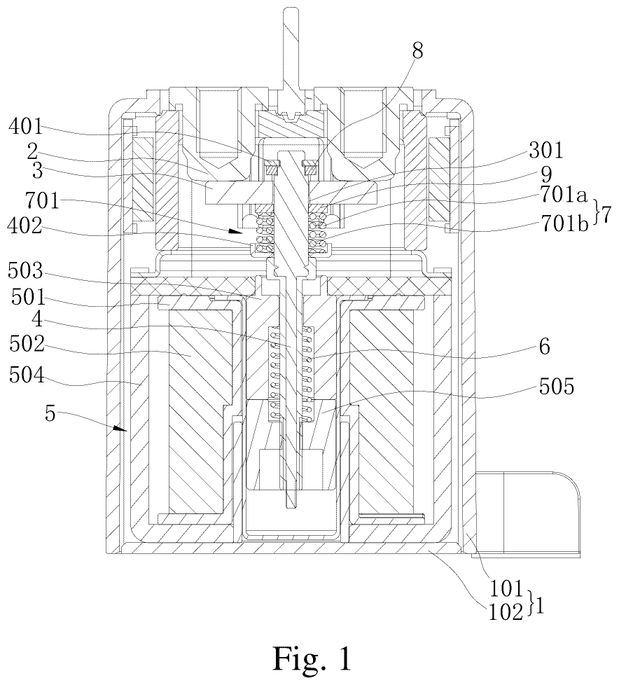

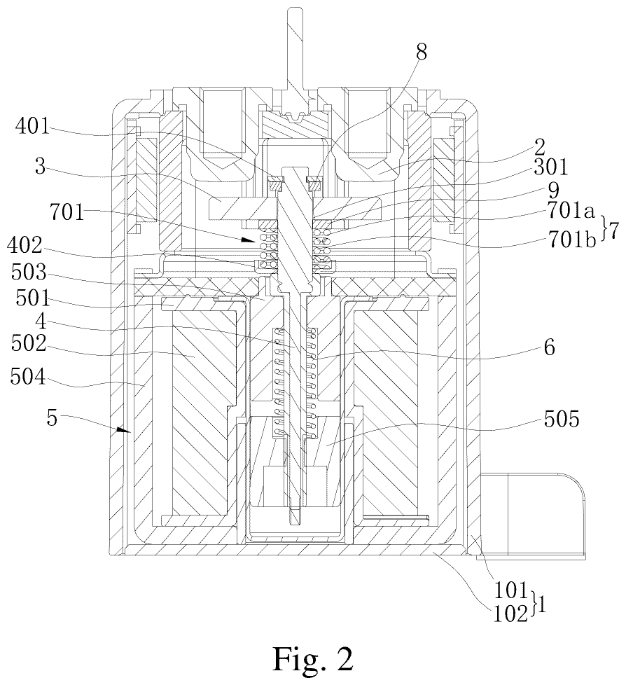

Referring to FIGS. 1-2, disclosed in the present disclosure is a relay, including a fixed base 1, a stationary contact 2, a movable contact plate 3, a push rod 4, an electromagnetic assembly 5, a reset elastic member 6, and an elastic assembly 7, in which the fixed base 1 includes an upper cover 101 and a bottom holder 102, and an interior of the upper cover 101 and the bottom holder 102 is formed with an accommodating chamber (not shown in figures) for mounting the stationary contact 2, the movable contact plate 3, the push rod 4, the electromagnetic assembly 5, the reset elastic member 6 and the elastic assembly 7.

The stationary contact 2 is fixed with respect to the fixed base 1, the movable contact plate 3 is provided with a movable contact (not shown in the figures) corresponding to the stationary contact 2, and the movable contact is provided facing the stationary contact 2. In the present embodiment, provided are two movable contacts and two stationary contacts 2, the movable contact may be abutted against the stationary contact 2, and is electrically conductive through the movable contact plate 3. The push rod 4 is movably provided with respect to the fixed base 1, connected to the movable contact plate 3, capable of driving the movable contact plate 3 to move reciprocally allowing the movable contact to move close to or away from the stationary contact 2. The electromagnetic assembly 5 is connected to the push rod 4 to drive the push rod 4 to move when energized. The reset elastic member 6 is connected to the push rod 4 to provide the push rod 4 with a reset elastic force. Provided is at least one set of the elastic assemblies, and each set of the elastic assemblies 7 includes at least two elastic members 701.

Referring to FIGS. 1-2, in some possible implementations, the movable contact plate 3 is slidably connected to the push rod 4, the sliding direction of the movable contact plate 3 is in a direction of the body of the push rod 4, i.e., in parallel to the moving direction of the push rod 4.

Specifically, the movable contact plate 3 is provided with a through slot 301, the push rod 4 is provided to pass through the through slot 301, and the movable contact plate 3 slides with respect to the push rod 4 in a direction of the body of the push rod 4.

The elastic assembly 7 is used to provide the movable contact plate 3 with an elastic pressing force, so that the movable contact plate 3 is kept to be abutted against the stationary contact 2 to resist the electric repulsion generated by the contact closure current.

When the electromagnetic assembly 5 drives the push rod 4 to move, and drives the movable contact plate 3 to move close to the stationary contact 2 so as to close the movable contact and the stationary contact 2, the electromagnetic assembly 5 continues to drive the push rod 4 to move forward. The movable contact plate 3 is pressed by the stationary contact 2 and slides with respect to the push rod 4, simultaneously rendering each elastic member 701 of the elastic assembly 7 to generate elastic force successively.

Referring to FIGS. 1, 2, 4, and 5, the relay further includes a first magnetically guiding sheet 8 and a second magnetically guiding sheet 9, in which the first magnetically guiding sheet 8 is provided on a side of the movable contact plate 3 facing the stationary contact 2, the second magnetically guiding sheet 9 is provided on a side of the movable contact plate 3 away from the stationary contact 3, both the first magnetically guiding sheet 8 and the second magnetically guiding sheet 9 are able to be magnetized by a current passing through the movable contact plate 3, the second magnetically guiding sheet 9 are able to be abutted against the surface of the first magnetically guiding sheet 8 to form a closed magnetic loop.

Referring to FIGS. 1-2, in some possible implementations, the first magnetically guiding sheet 8 is fixed to the push rod 4 and is positioned on a side of the movable contact plate 3 facing the stationary contact 2.

The second magnetically guiding sheet 9 is at least partially abutted against the surface on a side of the movable contact plate 3 away from the stationary contact 2, and the second magnetically guiding sheet 9 is provided facing the first magnetically guiding sheet 8, which is able to be close to the first magnetically guiding sheet 8 to form a closed magnetic loop.

Referring to FIGS. 1-2, the first magnetically guiding sheet 8 is provided on a side of the movable contact plate 3 facing the stationary contact 2, and is fixed to the push rod 4.

The second magnetically guiding sheet 9 is provided on a side of the movable contact plate 3 away from the stationary contact 2, and supports the movable contact plate 3.

When the contacts are opened, the second magnetically guiding sheet 9 may be abutted against a surface of the first magnetically guiding sheet 8 to form a closed magnetic loop. When the contacts are closed, a clearance is able to be formed between the second magnetically guiding sheet 9 and the surface of the first magnetically guiding sheet 8.

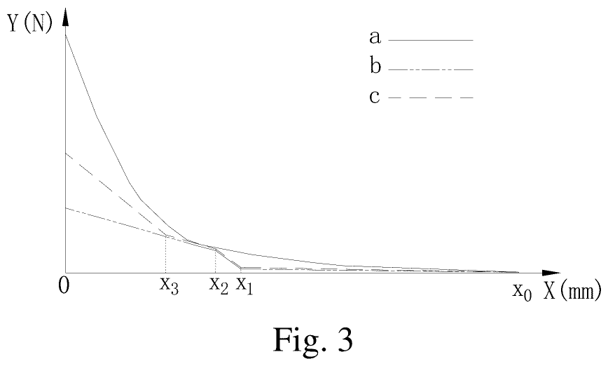

Referring to FIG. 3, the Y-axis represents the change in force (the electromagnetic attraction force of the electromagnetic assembly 5, the reverse elastic force of the elastic assembly 7 and the reset elastic member 6 as a whole, in Newtons), and the X-axis represents the change in the distance between the armature 505 and the fixed iron core 503 in the electromagnetic assembly 5, in millimeters. The curve a in the figure indicates the change of the electromagnetic attraction force generated by the coil 502 in the electromagnetic assembly 5 with the distance between the armature 505 and the fixed iron core 503, and the curve b indicates the change of the reverse elastic force applied by the elastic assembly 7 using two elastic members 701 to the movable contact plate 3 with the distance between the armature 505 and the fixed iron core 503.

When closing the movable contact and the stationary contact 2, in the interval of x₀-x₁, when the electromagnetic assembly 5 drives the movable contact 3 to move towards the stationary contact 2, before the movable contact contacts the stationary contact 2, the driving force and the change rate are relatively low. Therefore, the driving force of the electromagnetic assembly 5 mainly overcomes the reverse elastic force of the reset elastic member 6, until the movable contact 3 and the stationary contact 2 are abutted and closed (position x₁ of FIG. 3).

To ensure the tightness and reliability of the closure, after the movable contact and the stationary contact 2 are abutted and closed, the electromagnetic assembly 5 continues to drive the push rod 4 to move forward along its movement direction, the stationary contact 2 is abutted against and presses the movable contact plate 3 via the movable contact, and the movable contact plate 3 on the push rod 4 moves along a direction opposite to the movement of the push rod 4. In the interval 0-x₁, the elastic assembly 7 generates an elastic force acting on the movable contact plate 3, so that the movable contact plate 3 presses the stationary contact 2, so as to keep the stability of the closure between the movable contact and the stationary contact 2. The elastic force also acts on the push rod 4 in a direction opposite to the movement direction of the push rod 4, constituting the driving resistance of the electromagnetic assembly.

Before the movable contact is abutted against the stationary contact 2 and a short period time after the movable contact is abutted against the stationary contact 2, the driving force of the electromagnetic assembly 5 is relatively low. Therefore, the elastic assembly 7 is required to generate a relatively low reverse elastic force at the beginning of the contact closure. As shown in FIG. 3, in the interval x₁-x₂, only one elastic member 701 provides the elastic force. Otherwise, if the reverse elastic force generated by the elastic assembly 7 is relatively great when the movable contact contacts the stationary contact 2, the driving of the electromagnetic assembly 5 will be greatly affected. For example, if the combined force of the elastic force generated by the elastic assembly 7 and the reset elastic force is greater than the driving force generated by the electromagnetic assembly 5 on the push rod 4, the push rod 4 is unable to move under the driving of the electromagnetic assembly 5, resulting in the armature 505 and the fixed iron core 503 in the electromagnetic assembly 5 not being able to be closed, the stability of the contact closure being poor, and the contact being likely to be detached.

As the distance between the armature 505 and the fixed iron core 503 in the electromagnetic assembly 5 is decreased, the driving force of the electromagnetic assembly 5 continues to increase, and the increasing rate of the driving force increases, and the pushing force generated by the electromagnetic assembly 5 is gradually able to resist a greater reverse elastic force. Thus, in the interval x₂-x₃, another elastic member 701 acts to provide an elastic force together with the previous elastic member 701. In such a way, eventually, after the armature 505 and the stationary iron core of the electromagnetic assembly 5 are closed, a reverse elastic force against the stationary contact 2 is provided to the movable contact plate 3 by two elastic members 701 together, so that the movable contact on the movable contact plate 3 is kept tightly pressed against the stationary contact 2 even if the relay is subjected to a large electric repulsion by means of a large short-circuit current. At this moment, as the elastic assembly 7 is able to resist this anomalous movement and maintain the stability of the contact between the movable contact and the static contact 2, the elastic assembly 7 is able to provide an adapted reverse elastic force in response to changes in the electromagnetic attraction force of the electromagnetic assembly 5, which facilitates the achievement of improving the stability of the operation of the relay while maintaining a small volume and a low coil 502 power to meet the needs of the actual application process.

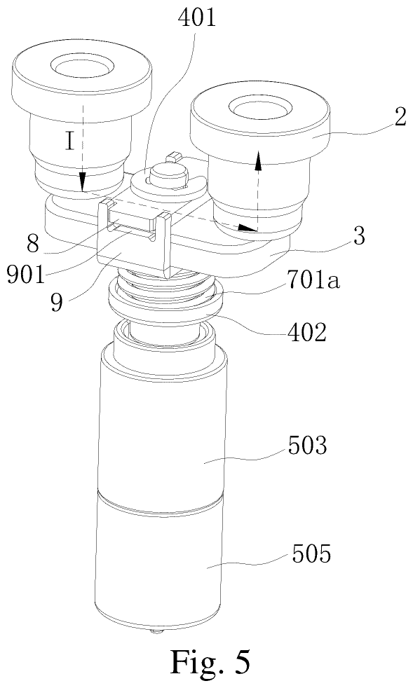

Referring to FIG. 5, after the movable contact on the movable contact plate 3 is closed with the stationary contact 2, illustratively, when the current I flows from the stationary contact 2 at an end of the movable contact plate 3 to the stationary contact 2 at an opposite end of the movable contact plate 3 in the direction shown in the figure, due to the magnetic effect of the energized current I in the movable contact plate 3, an electromagnetic is formed in the closed magnetic loop formed by the first magnetically guiding sheet 8 and the second magnetically guiding sheet 9, which allows the first magnetically guiding sheet 8 and the second magnetically guiding sheet 9 to be attracted to each other, thereby providing pressure for the movable contact plate 3 in the direction facing the stationary contact 2, further increasing the tightness of the closure of the movable contact on the movable contact plate 3 to the stationary contact 2, and improving the reliability of the relay when it is subjected to a high-current shock.

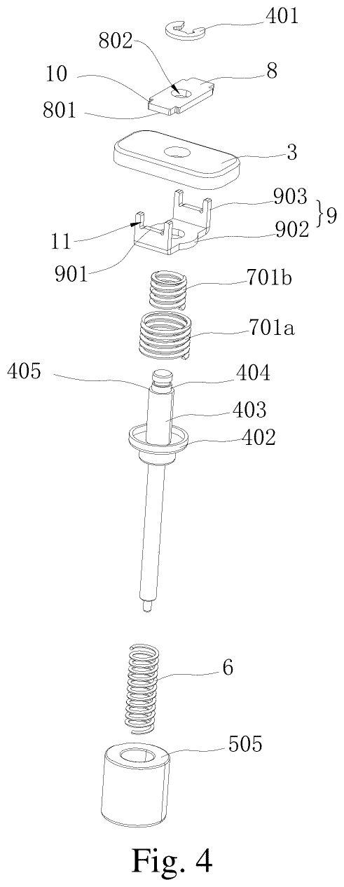

Referring to FIGS. 4-5, a side of the first magnetically guiding sheet 8 facing the second magnetically guiding sheet 9 is provided with a first magnetic attraction surface 801, a side of the second magnetically guiding sheet 9 facing the first magnetically guiding sheet 8 is provided with a second magnetic attraction surface 901, and the first magnetic attraction surface 801 and the second magnetic attraction surface 901 are provided facing each other.

In such an arrangement, when the current I passes through the movable contact plate 3 in the direction shown in FIG. 5, it leads to the magnetization of the first magnetic attraction surface 801 to the N pole, to the magnetization of the second magnetic attraction surface 901 to the S pole, and the first magnetic attraction surface 801 and the second magnetic attraction surface 901 are attracted to each other. Thus, under the action of such electromagnetic force, the first magnetically guiding sheet 8 and the second magnetically guiding sheet 9 are brought close to each other so as to enable to offset a part of the electric repulsion force due to the high-current flowing through the stationary contact 2 and the movable contact of the movable contact plate 3.

Referring to FIG. 4, as a possible implementation, one of the first magnetically guiding sheet 8 and the second magnetically guiding sheet 9 is provided with a sliding protrusion 10, and the other one is provided with a sliding slot 11 for the sliding protrusion 10 to slide.

In such an arrangement, by setting slide cooperation between the sliding protrusion 10 and the sliding slot 11, the second magnetically guiding sheet 9 slides stably with respect to the first magnetically guiding sheet 8, thereby preventing the occurrence of shifting.

In the present embodiment, the slide protrusion 10 is provided on the first magnetically guiding sheet 8, and the slide slot 11 is provided on the second magnetically guiding sheet 9.

Admittedly, in other possible implementations, the slide protrusion 10 may be provided on the second magnetically guiding sheet 9, and the sliding slot 11 may be provided on the first magnetically guiding sheet 8.

Referring to FIG. 4, in the present embodiment, the first magnetically guiding sheet 8 is of a flat plate shape, the second magnetically guiding sheet 9 is provided as U-shaped, the second magnetically guiding sheet 9 includes one horizontal end 902 abutted against the lower surface of the movable contact plate 3 and vertical ends 903 provided on both ends of the horizontal end 902, and the second magnetic attraction surface 901 is provided on an end of the vertical end 903.

Admittedly, in other possible implementations, the first magnetically guiding sheet 8 may be provided as U-shaped, and the second magnetically guiding sheet 9 is of a flat plate shape.

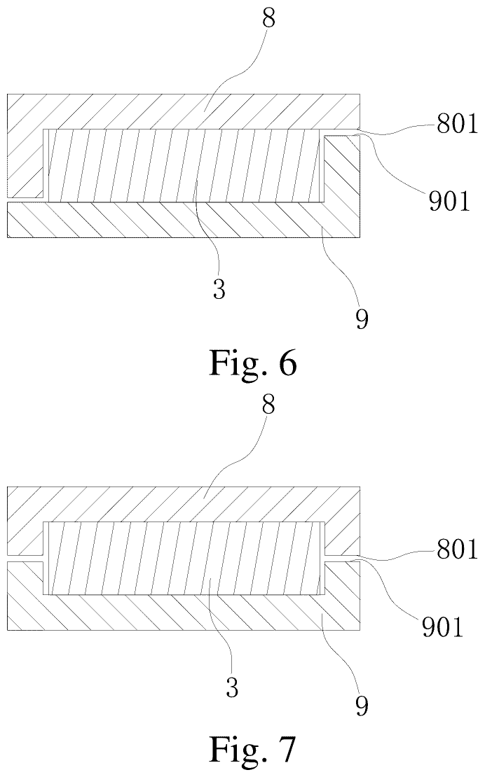

Referring to FIG. 6, in other possible implementations, the first magnetically guiding sheet 8 and the second magnetically guiding sheet 9 may be an L-shaped cooperated with each other.

Referring to FIG. 7, in other possible implementations, the first magnetically guiding sheet 8 and the second magnetically guiding sheet 9 may be a U-shaped cooperated with each other.

As a possible implementation, referring to FIG. 1 and FIG. 2, each set of the elastic assembly 7 includes a first elastic member 701a and a second elastic member 701b, in which the first elastic member 701a and the second elastic member 701b are provide on the same side of the movable contact plate 3.

Further, as a possible implementation, both the first elastic member 701a and the second elastic member 701b are compression springs.

Referring to FIG. 1 and FIG. 2, the push rod 4 is provided with a first restricting member 401 and a second restricting member 402, in which the first restricting member 401 is positioned on an end of the push rod 4, the second restricting member 402 is positioned on a side of the movable contact plate 3 away from the stationary contact 2, the first elastic member 701a and the second elastic member 701b are of different length, the length of the first elastic member 701a is greater than that of the second elastic member 701b, both the first elastic member 701a and the second elastic member 701b are positioned between the second restricting member 402 and the movable contact plate 3, and both of them are able to apply an elastic force to the movable contact plate 3 in a direction facing the stationary contact 2.

Admittedly, the length of the second elastic member 701b may also be greater than the first elastic member 701a. It is only to facilitate the distinction between them, the following description of the structure and principles is provided with an implementation in which the length of the first elastic member 701a is greater than that of the second elastic member 701b.

In such an arrangement, the first restricting member 401 and the second restricting member 402 restrict the positions of the movable contact plate 3 and the elastic assembly 7, the compression spring is adopted as the elastic member, and the length of the first elastic member 70la is greater than that of the second elastic member 701b. After the movable contact plate 3 is abutted against the stationary contact 2, when the push rod 4 continues to move forward, the movable contact plate 3 moves in a direction opposite to the movement of the push rod 4 and successively compresses the first elastic member 701a and the second elastic member 701b. The elastic force applied by the elastic assembly 7 to the movable contact plate 3 increases as the distance moved by the movable contact plate 3 in the opposite direction of the push rod 4 increases. Therefore, after the armature 505 and the stationary iron core in the electromagnetic assembly 5 are closed and stop driving, the elastic assembly 7 provides the movable contact plate 3 with sufficient elastic pressing force, the movable contact of the movable contact plate 3 keeps a stable connection with the stationary contact 2, which is able to resist the electric repulsion generated by the contact through a large short-circuit current, and has high stability.

Further, in the present embodiment, the first restricting member 401 is a clamp, a snap-fit connection between the clamp and the push rod 4 restricts the movement of the movable contact plate 3, which prevents the movable contact plate 3 from detaching from an end of the push rod 4, with such structure arrangement facilitating assembly.

Referring to FIGS. 4-5, in the present embodiment, the push rod 4 includes a main body 403 and a sleeve shaft segment 404 provided on an end of the main body 403. The diameter of the sleeve shaft segment 404 is less than that of the main body 403, so that the sleeve shaft segment 404 and the main body 403 form a step segment for restricting positions. The first magnetically guiding sheet 8 is provided with a connection hole 802 for passing through the sleeve shaft segment 404. By means of the connection hole 802, the first magnetically guiding sheet 8 is sheathed to the sleeve shaft segment 404, so that the first magnetically guiding sheet 8 is connected to the step segment 405. Then, the clamp is connected to the sleeve shaft segment 404, so as to fix the first magnetically guiding sheet 8 to the push rod 4.

The second restricting member 402 may also be provided as a clamp, or the second restricting member 402 and the push rod 4 are formed integrally.

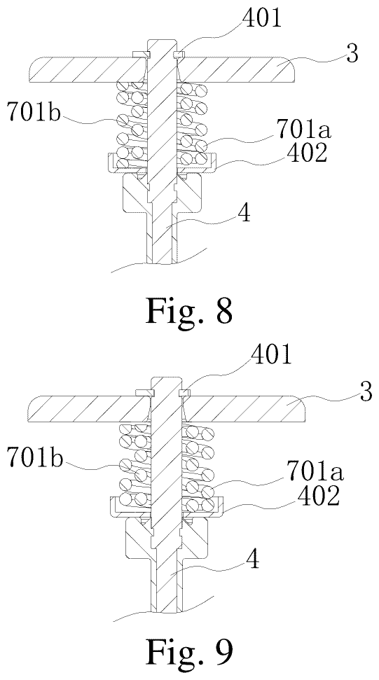

As a possible implementation, referring to FIGS. 1, 2, 8, and 9, further, all elastic members 701 are provided in a nested configuration in the same elastic assembly 7.

In such an arrangement, all elastic members 701 are provided in a nested configuration in the elastic assembly 7, which may reduce the space occupied and contribute to the miniaturization of the product design.

As a possible implementation, when the elastic members 701 are provided in a nested configuration, the arrangement may be: an elastic member 701 of shorter length is sheathed to an exterior of an elastic member 701 of longer length, i.e., the second elastic member 701b is sheathed to an exterior of the first elastic member 701a; or an elastic member 701 of longer length is sheathed to an exterior of an elastic member 701 of shorter length, i.e., the first elastic member 701a is sheathed to an exterior of the second elastic member 701b, in which both implementations may achieve the compactness and miniaturization of the elastic assembly 7.

As a possible implementation, referring to FIGS. 1, 2, 8, one of the second restricting member 402 and the movable contact plate 3 is fixed to an end of the first elastic member 701a, the other one is connected to, abutted against, or maintains a gap with an opposite end of the first elastic member 701a.

Preferably, the second restricting member 402 is fixed to an end of the first elastic member 701a, the movable contact plate 3 is abutted against an opposite end of the first elastic member 701a. The first elastic member 701a generates a certain amount of initial deformation, so that the movable contact plate 3 is abutted against the surface of the first restricting member 401, avoiding leaving a clearance and generating a noise by slipping and colliding when the relay is mounted inverted.

Admittedly, when the relay is used in an upright state, the arrangement may be: the first elastic member 701a is abutted against the lower surface of the movable contact plate 3, at which time the compression spring generates a low elastic pressing force to support the weight of the movable contact plate 3.

Due to the length limitation of the second elastic member 701b, a clearance is kept between the second elastic member 701b and the surface of the movable contact plate 3 when the movable contact plate 3 is not pressed by the stationary contact 2 and is moved with respect to the push rod 4.

In such an arrangement, after the movable contact plate 3 is pressed by the stationary contact 2 and moves with respect to the push rod 4, the movable contact plate 3 moves in a direction toward the second restricting member 402. The movable contact plate 3 compresses the first elastic member 701a with longer length first to allow it to generate an elastic force. As the distance between the movable contact plate 3 and the second limiting member 402 is shortened, the movable contact plate 3 is able to press against the second elastic member 701b with shorter length, allowing it to generate an elastic force. In such an arrangement, each elastic member 701 of the elastic assembly 7 is compressed to generally generate elastic force to adapt to the change of electromagnetic force of the electromagnetic assembly 5.

In some possible implementations, the second magnetically guiding sheet 9 is fixedly connected to the movable contact plate 3, in which the fixing methods include, but are not limited to, bonding and welding.

Referring to FIGS. 1-2, in some possible implementations, the second magnetically guiding sheet 9 is abutted against the surface of the movable contact plate 3 via the first elastic member 701a, so that the second magnetically guiding sheet 9 is abutted against the surface of the movable contact plate 3.

Referring to FIG. 9, in some possible implementations, the arrangement may be: a middle of the compression spring is fixed to the push rod 4; both ends of the compression spring are abutted against at least one of the movable contact plates 3 and the second restricting member 402, or both ends of the compression spring keep a clearance with the movable contact plate 3 and the second restricting member 402.

Referring to FIGS. 1-2, further, in the present embodiment, provided is one set of the elastic assemblies 7, and the elastic assembly 7 is positioned on a center of the movable contact plate 3.

In such an arrangement, it may allow balanced force on the movable contact plate 3, simplify the structure and reduce troublesome assembly by adopting fewer elastic assemblies 7 under the premise of providing sufficient reverse elastic force to resist the electric repulsion.

Further, in some possible implementations, all elastic members 701 have a same elastic coefficient in the same elastic assembly 7.

Further, in some other possible implementations, all elastic members 701 have different elastic coefficients in the same elastic assembly 7.

Preferably, in the same elastic assembly 7, the elastic coefficient of each elastic member 701 increases with the increasing order of the elastic force that it generates, i.e., the elastic coefficient of the elastic member 701 that generates the elastic force first is less than the elastic coefficient of the elastic member 701 that generates the elastic force later. In the present embodiment, the elastic coefficient of the first elastic member 701a is less than that of the second elastic member 701b, and the elastic coefficient of the elastic member 701 that is compressed first is less than that of the elastic member 701 that is compressed later. In other words, the rigidity of the elastic member 701 that is compressed first is less than that of the elastic member 701 that is compressed later, and the elastic force generated by the elastic member 701 during deformation is related to the elastic coefficient, so that the elastic member 701 that is compressed first generates a lower reverse elastic force on the movable contact plate 3, and the elastic member 701 that is compressed later generates an additionally increased and greater reverse elastic force on the movable contact plate 3.

Therefore, by setting different elastic members 701 with different elastic coefficient, when the movable contact plate 3 is abutted against the stationary contact 2 and moves, the elastic member 701 with a smaller elastic coefficient generates a reverse elastic force before the elastic member 701 with a larger coefficient of elasticity. In such an arrangement, it is possible to adapt to a lower driving force that is provided by the electromagnetic assembly 5, and as the push rod 4 continues to move forward, the elastic coefficient of the elastic member 701 participating in the reverse elastic force is gradually increased, i.e., it is capable of providing a greater reverse elastic force, i.e., it is able to adapt to the process of the subsequent gradual increase of the driving force provided by the electromagnetic assembly 5. Such a setup is better matched to the changing process of the driving force of the electromagnetic assembly 5 and ultimately provides the optimal reverse elastic force to stabilize the connection between the movable contact and the stationary contact 2 by offsetting the electric repulsion. Therefore, if further facilitates the achievement of a small size and low power design of the electromagnetic assembly 5.

Admittedly, in other possible implementations, the arrangement may be: an elastic coefficient of the elastic member 701 generating elastic force later is less than that of the elastic member 701 generating elastic force first in the same elastic assembly 7.

Admittedly, in other possible implementations, when the elastic assembly 7 is provided with at least three elastic members 701, the elastic coefficient of the elastic member 701 may be set to increase with the order in which the elastic force is generated, with the elastic coefficient being set to be first greater and then lesser.

Further, the electromagnetic assembly 5 includes a coil support 501, a coil 502, a fixed iron core 503, a yoke 504, and an armature 505, the coil 502 is sheathed to an exterior of the fixed iron core 503, both the fixed iron core 503 and the yoke 504 are fixed to the coil support 501, the armature 505 is fixedly connected to the push rod 4, the yoke 504 and the fixed iron core 503 generate a magnetic flux when the coil 502 is energized, and the magnetic flux tends to form a closed magnetic loop to drive the armature 505 to move close to the fixed iron core 503.

In such an arrangement, when the coil 502 is energized, an electromagnetic flux is generated in the fixed iron core 503 and the yoke 504, and the magnetic loop formed by the flux tends to close. Then, the armature 505 is attracted to move in the direction close to the iron core, so as to drive the push rod 4 to move in order to achieve the closure of the movable contact and the stationary contact 2 in the relay. During the gradual approach of the armature 505 to the fixed iron core 503, i.e., during the gradual decrease of the distance between them, the curve of the change in the magnetic attraction force that the coil 502 is able to provide is shown as the curve a in FIG. 3. When the coil 502 is de-energized, the electromagnetic flux vanishes, so that the push rod 4 is reset by the elastic force of the elastic assembly 7 and the reset elastic member 6.

The process and principles of the implementation of the embodiments of the present disclosure are as follows:

When the contacts are closed, the coil 502 is energized to allow an electromagnetic flux to generate in the fixed iron core 503 and the yoke 504, and the magnetic loop formed by the flux tends to close. Then, the armature 505 is attracted to move in the direction close to the iron core, so as to drive the push rod 4 to move in order to allow the movable contact and the stationary contact to be abutted and closed.

After the movable contact on the movable contact plate 3 is closed with the stationary contact 2, when the current flows from the stationary contact 2 at one end of the movable contact plate 3 to the stationary contact 2 at the other end, due to the magnetic effect of the energized current I in the movable contact plate 3, an electromagnetic is formed in the closed magnetic loop formed by the first magnetically guiding sheet 8 and the second magnetically guiding sheet 9, which allows the first magnetically guiding sheet 8 and the second magnetically guiding sheet 9 to be attracted to each other, thereby providing the movable contact plate 3 with a pressing force in a direction toward the stationary contact 2, further increasing the tightness of the closure of the movable contact on the movable contact plate 3 to the stationary contact 2, and improving the reliability when subjected to a high-current shock.

After the movable contact is closed against the stationary contact 2, the electromagnetic assembly 5 continues to drive the push rod 4 to move forward in a direction of its movement, and the stationary contact 2 presses against the movable contact plate 3 via the movable contact, so that the movable contact plate 3 slides on the push rod 4 in the opposite direction of the movement of the push rod 4 and in a direction close to the second restricting member 402. That is, the movable contact plate 3 moves in a direction close to the second restricting member 402 and compresses each elastic member 701 of the elastic assembly 7 sequentially. Specifically, in the position as shown by x1 in FIG. 3, the movable contact plate 3 first compresses the first elastic member 701a with a longer length, so that the elastic assembly 7 generates a lower reverse elastic force on the movable contact plate 3. At this moment, the combined force of the elastic assembly 7 and the reset elastic member 6 is lower than the driving force provided by the electromagnetic assembly 5 for the forward movement of the push rod 4, and the electromagnetic assembly 5 is able to continue to push the push rod 4 forward in this case.

As the electromagnetic assembly 5 continues to drive the push rod 4 forwards, the movable contact plate 3 continues to move in a direction close to the second restricting member 402 under the abutment of the static contact 2. In the position shown as x2 in FIG. 3, the movable contact plate 3 gradually presses against the second elastic member 701b with a shorter length, so that the second elastic member 701b also applies a reverse elastic force on the movable contact plate 3 until X=0 mm. The elastic force generated by the second elastic member 701b is stacked with the elastic force generated by the first elastic member 701a to provide a greater reverse elastic force on the movable contact plate 3, thereby providing a stable pressing force for the movable contact plate 3 to remain against the stationary contact 2 in order to resist the electric repulsion generated by the larger short-circuit currents that may flow through the relay, and to keep the stability of the movable contact closing against the stationary contact 2.

When the coil 502 is de-energized, the electromagnetic flux vanishes, so that the push rod 4 is reset by the combined action of the elastic assembly 7 and the reset elastic member 6.

### Embodiment 2

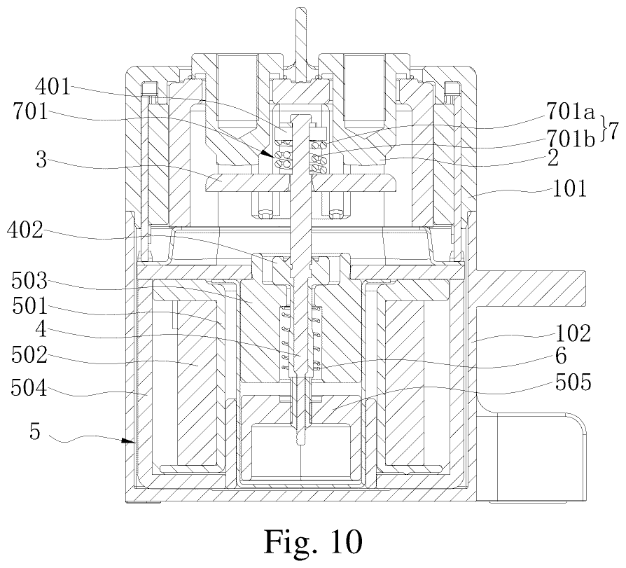

Referring to FIG. 10, disclosed in the present disclosure is also another relay. On the basis of the above embodiments, the present embodiment differs from the above embodiments only in that:

In the present embodiment, both the first elastic member 701a and the second elastic member 701b are tension springs, both the first elastic member 701a and the second elastic member 701b are positioned between the second restricting member 402 and the movable contact plate 3, an end of the tension spring is fixed to the first restricting member 401, an opposite end thereof is connected to the movable contact plate 3, a length of the first elastic member 7 is greater than that of the second elastic member 701b, and they both are able to apply an elastic force to the movable contact plate 3 in a direction facing the stationary contact 2.

In such an arrangement, as another implementation, the tension spring is adopted as the elastic member 701, and the tension spring is connected to the movable contact plate 3. When the push rod 4 continues to move forward after the movable contact plate 3 is abutted against the stationary contact 2, the movable contact plate 3 moving with respect to the push rod 4 drives each elastic member 701 to be pulled successively, so that the tension spring provides the movable contact plate 3 with an elastic pulling force in an opposite direction to the movement thereof. In such an arrangement, it resists the electric repulsion of the relay due to the great short-circuit current and avoids the disengagement of the movable contact from the stationary contact 2.

Due to the different lengths of the elastic members 701 of the same elastic assembly 7, when the movable contact plate 3 moves without being pressed against the stationary contact 2, the elastic member 701 with a shorter length stays tensioned while the elastic member 701 with a longer length stays loose, and it relies only on the elastic member 701 with a shorter length to provide a slight elastic force for balancing the gravity of the movable contact plate 3 and keeping the movable contact plate 3 stable.

The operation process and the principle of the embodiments of the present disclosure are as follows:

The implementation process differs from that of Embodiment 1 only in that: after the movable contact is abutted against and closed with the stationary contact 2, the electromagnetic assembly 5 continues to drive the push rod 4 to move forwards in the moving direction thereof, and the stationary contact 2 is pressed against the movable contact plate 3 via the movable contact, so that the movable contact plate 3 moves on the push rod 4 in a direction opposite to the movement of the push rod 4, i.e., the movable contact plate 3 moves in a direction away from the first restricting member 401, and pulls each elastic member 701 of the elastic assembly 7 sequentially. Specifically, in the position as shown by x1 in FIG. 3, the movable contact plate 3 first pulls the second elastic member 701b with shorter length, so that the elastic member 701 generates a lower reverse elastic force on the movable contact plate 3, which has a reduced effect on the continued forward movement of the push rod 4, and the movable contact plate 3 continues to move under the pressing of the stationary contact 2 in a direction close to the second restricting member 402 while the electromagnetic assembly 5 continues to drive the push rod 4 forward. In the position shown as x2 in FIG. 3, the movable contact plate 3 gradually pulls the first elastic member 701a with longer length, so that the first elastic member 70la also applies a reverse elastic force on the movable contact plate 3 until X=0 mm. This elastic force is stacked with the previous elastic force generated by the first elastic member 701a to provide a greater reverse elastic force on the movable contact plate 3, thereby providing a stable pressing force for the movable contact plate 3 to remain against the stationary contact 2 in order to resist the electric repulsion generated by the larger short-circuit currents that may flow through the relay, and to keep the stability of the movable contact closing against the stationary contact 2.

### Embodiment 3

Disclosed in the present disclosure is also another relay. On the basis of the above embodiments, the present embodiment differs from the above embodiments only in that:

In the present embodiment, the first elastic member 701a is a tension spring, the second elastic member 701b is a compression spring, the first elastic member 701a is positioned between the first restricting member 401 and the movable contact plate 3, the second elastic member 701b is positioned between the second restricting member 402 and the movable contact plate 3, and both the first elastic member 701a and the second elastic member 701b are able to apply an elastic force to the movable contact plate 3 in a direction toward the stationary contact 2.

In such an arrangement, as another implementation, when the push rod 4 continues to move forward after the movable contact plate 3 is abutted against the stationary contact 2, the first elastic member 701a and the second elastic member 701b positioned on both sides of the movable contact plate 3 successively apply an elastic force to the movable contact plate 3 in a direction facing the stationary contact 2. Specifically, it may be that the first elastic member 701a first generates an elastic pulling force to keep the movable contact plate 3 abutted against the stationary contact 2, while the second elastic member 701b later generates an elastic pressing force, which is stacked with the elastic pulling force of the first elastic member 701a, to further provide an abutting contact force for the abutting connection of the movable contact plate 3 and the stationary contact 2.

In such an arrangement, adopting the solution of the present embodiment also generates an elastic abutting pressing force between the movable contact plate and the stationary contact, and may resist the electric repulsion of the relay due to the great short-circuit current to maintain the stability of the closing of the contacts.

Admittedly, setting the first elastic member 701a as a compression spring and the second elastic member 701b as a tension spring can also be adjusted with reference to the above arrangement to achieve the purpose of the invention.

### Embodiment 4

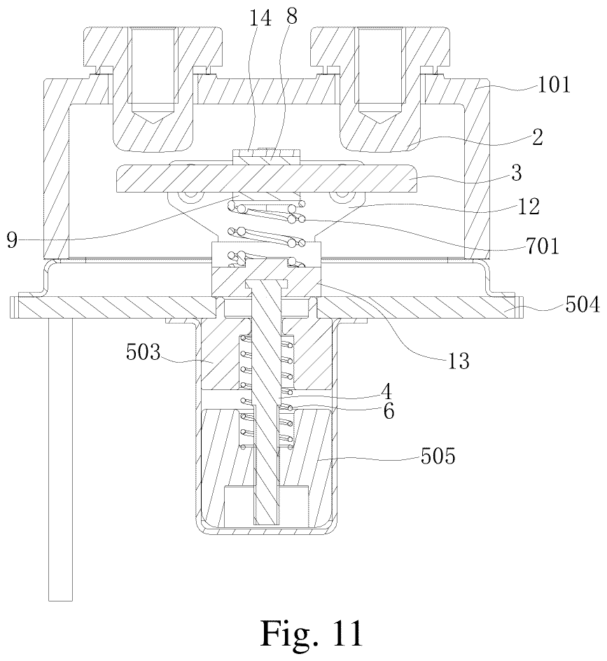

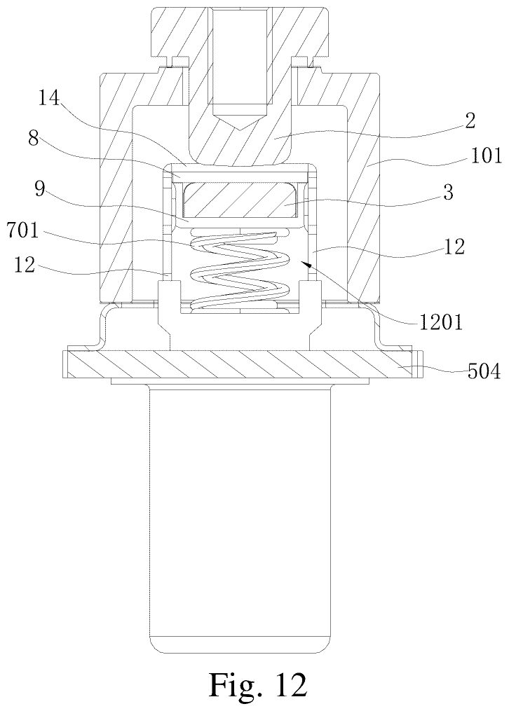

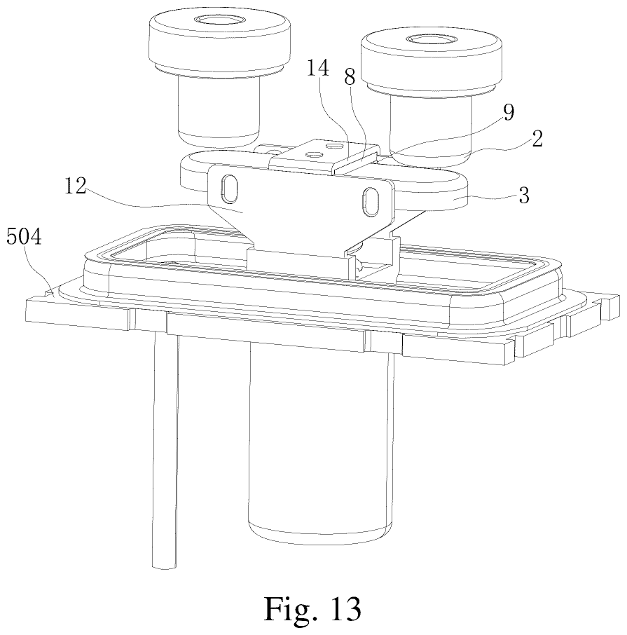

Referring to FIGS. 11-13, disclosed in the present disclosure is also another relay. On the basis of any one of Embodiments 1-3, the present embodiment differs from the aforementioned embodiments only in that:

In the present embodiment, both sides of the movable contact plate 3 are provided with a guiding plate 12 respectively, and two guiding plates 12 are spacing apart to form a guiding channel 1201 for the movable contact plate 3 to slide.

By providing the guiding plate 12 on both sides of the movable contact plate 3, a guiding channel 1201 is formed for the movable contact plate 3 to slide, so as to provide a sliding guide for the movable contact plate 3, reducing the possibility of overturning or horizontal rotation of the movable contact plate 3, which is conducive to the reliability of the closing and opening between the movable contact and the stationary contact 2.

In some possible implementations, the guiding plate 12 is fixed to the push rod 4.

In other possible implementations, the guiding plate 12 is provided on the fixed base 1, which may be fixed to the fixed base 1 or movably provided with respect to the fixed base 1 and moves with the movement of the push rod 4.

In some possible implementations, an end of the push rod 4 is connected with a fixing plate 13, two guiding plates 12 are fixed to the fixing plate 13, the movable contact plate 3 is connected to the fixing plate 13 via the elastic member, and the movable contact plate 3 moves in the guiding channel 1201 formed between two guiding plates 12 in a direction close to or away from the guiding plate 12.

Further, the first magnetically guiding sheet 8 is fixed on an end of the guiding plate 12 away from the fixing plate 13, and may be abutted against the upper surface of the movable contact plate 3.

The second magnetically guiding sheet 9 is provided below the movable contact plate 3, and may be abutted against the lower surface of the movable contact plate 3.

Further, in some possible implementations, for avoiding the movable contact plate 3 from detaching from the guiding channel 1201, a restricting plate 14 is provided on a side of the guiding plate 12 away from the fixing plate 13.

Further, in some possible implementations, when the elastic member 701 is provided as a tension spring, an end of the tension spring is connected to the restricting plate 14, and an opposite end thereof is connected to the movable contact plate 3. When the elastic member 701 is provided as a compression spring, an end of the compression spring is connected to the fixing plate 13, and an opposite end thereof is connected to the movable contact plate 3.

As shown in FIGS. 11-13, the first magnetically guiding sheet 8 is fixed to the restricting plate 14, the elastic member 701 is a compression spring, the compression spring supports the second magnetically guiding sheet 9, so that the second magnetically guiding sheet 9 is abutted against the lower surface of the movable contact plate 3.

The working principle of the present embodiment of the disclosure is similar to that of the above embodiments and is not repeated herein.

### Embodiment 5

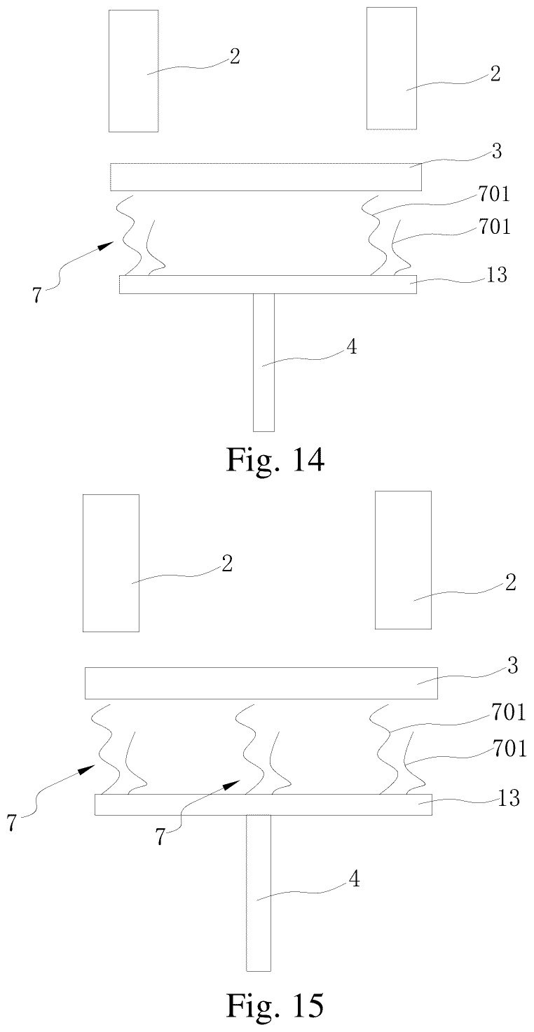

Referring to FIG. 14, disclosed in the present disclosure is also another relay. On the basis of Embodiment 1, the present embodiment differs from Embodiment 1 only in that:

All elastic members 701 are provided in parallel along a stretching direction in the same elastic assembly 7.

In such an arrangement, in case of sufficient space, it is also possible to provide at least two elastic members 701 of the elastic assembly 7 independently in a parallel arrangement.

The second restricting member 402 is provided in the form of a plate, and there are provided at least two sets of elastic assemblies 7. As shown in FIG. 14, the elastic assemblies 7 are provided in two sets, and all elastic assemblies 7 are provided centrosymmetrically with respect to the movable contact plate 3.

### Embodiment 6

Referring to FIG. 15, disclosed in the present disclosure is also another relay. On the basis of Embodiment 1, the present embodiment differs from Embodiment 1 only in that:

As shown in FIG. 15, provided are three sets of the elastic assemblies 7, in which all elastic assemblies 7 are provided centrosymmetrically with respect to the movable contact plate 3.

In such an arrangement, by means of at least two sets of the elastic assemblies 7, a balanced and sufficient reverse elastic force is provided to the movable contact plate 3.

### Embodiment 7

Disclosed in the present disclosure is also another relay. On the basis of Embodiment 1 or Embodiment 2, the present embodiment differs from Embodiment 1 or Embodiment 2 only in that:

The elastic assembly 7 includes a first elastic member 701a, a second elastic member 701b, and a third elastic member (not shown in figures), in which the length of the first elastic member 701a, the second elastic member 701b, and the third elastic member are L1, L2, and L3 respectively, and L1>L2>L3.

The present embodiment works as follows:

On the basis of the embodiment 1, it differs from the embodiment 1 in that:

Referring to FIG. 3, curve c indicates the change of the reverse elastic force applied by the elastic assembly 7 to the movable contact plate 3 using the three elastic members 701 with the distance between the armature 505 and the fixed iron core 503.

In the interval x₀-x₃, the elastic assembly 7 mainly relies on the first elastic member 701a and the second elastic member 701b to provide the elastic force. In the interval of 0-x₃, the third elastic member generates an elastic force, which is stacked with the elastic force generated by the first elastic member 701a and the second elastic member 701b, and they collectively provide a pressing force against the movable contact of the movable contact plate 3 and the stationary contact 2. Further, the elastic force curve is made to be close to the driving force that the electromagnetic assembly 5 is able to provide, maintaining the stability of the contact of the contacts.

### Embodiment 8

Disclosed in the present disclosure is also another relay. On the basis of Embodiment 5, the present embodiment differs from Embodiment 5 or Embodiment 2 only in that:

The elastic assembly 7 includes a first elastic member 701a, a second elastic member 701b, and a third elastic member (not shown in figures), in which the first elastic member 701a, the second elastic member 701b, and the third elastic member are of same or different length.

In summary, in the relay provided in the present disclosure, provided are a first magnetically guiding sheet 8 and a second magnetically guiding sheet 9, after the movable contact plate 3 is closed with the stationary contact 2, when the current flows through the movable contact plate 3, with the current change forming a closed magnetic loop between the first magnetically guiding sheet 8 and the second magnetically guiding sheet 9 to offset a part of the electric repulsion generating by the high-current flowing through the stationary contact 2 and the movable contact of the movable contact plate 3. The at least two elastic members 701 provided by the elastic assembly 7 provide a reverse elastic force for the movable contact plate 3 after the movable contact contacts the stationary contact 2. Compared to adopting a single elastic member 701, the elastic assembly 7 is capable of adapting to the changing course of the driving force provided by the electromagnetic assembly 5 and providing a greater reverse elastic force in the final state. It is better applicable to the driving force of the electromagnetic assembly 5, which not only reduces the influence on the electromagnetic assembly 5 to continue to drive the push rod 4 to move forward, but also provides a stronger reverse elastic force to resist the influence of the electric repulsion on the closure of the movable contact and the stationary contact 2, and improves the stability of the operation of the relay to meet the requirements of the actual application process while maintaining the small size and the low coil 502 power.

The technical means disclosed in the solution of the present disclosure are not limited to those disclosed in the embodiments mentioned above but also include technical solutions consisting of any combination of the above technical features. It should be noted that for those skilled in the art, a plurality of improvements and modifications may be made without departing from the principles of the present disclosure. These improvements and modifications are also considered to be within the scope of protection of the present disclosure.

1. A relay, comprising:
a fixed base;
a stationary contact, fixed with respect to the fixed base;
a movable contact plate, provided with a movable contact corresponding to the stationary contact;
a push rod, slidable with respect to the fixed base, the movable contact plate being movably provided, in a direction parallel to a sliding direction of the push rod, with respect to the push rod;
an electromagnetic assembly, used to driving the push rod to slide;
a reset elastic member, used to provide an elastic force for disengagement of the movable contact from the stationary contact;
at least one set of elastic assemblies, whose elastic force acts on the push rod and the movable contact plate, the elastic assembly comprising at least two elastic members;
a first magnetically guiding sheet; and
a second magnetically guiding sheet,
wherein the first magnetically guiding sheet is provided on a side of the movable contact plate facing the stationary contact, the second magnetically guiding sheet is provided on a side of the movable contact plate away from the stationary contact, both the first magnetically guiding sheet and the second magnetically guiding sheet are able to be magnetized by a current passing through the movable contact plate, the second magnetically guiding sheet and the first magnetically guiding sheet are able to form a closed magnetic loop,
the electromagnetic assembly drives the push rod to slide, and, after the push rod drives the movable contact plate to move so as to close the movable contact and the stationary contact by means of at least one of the elastic members, and an elastic force of remaining elastic members acts on the movable contact plate to increase a pressing force between the movable contact and the stationary contact, as the push rod continues to slide.

2. The relay according to claim 1, wherein a side of the first magnetically guiding sheet facing the second magnetically guiding sheet is provided with a first magnetic attraction surface, a side of the second magnetically guiding sheet facing the first magnetically guiding sheet is provided with a second magnetic attraction surface, and the first magnetic attraction surface and the second magnetic attraction surface are provided facing each other.

3. The relay according to claim 1, wherein one of the first magnetically guiding sheet and the second magnetically guiding sheet is provided with a sliding protrusion, and the other one is provided with a sliding slot for the sliding protrusion to slide.

4. The relay according to claim 1, wherein one of the first magnetically guiding sheet and the second magnetically guiding sheet is of a flat plate shape, the other one is U-shaped;
or both the first magnetically guiding sheet and the second magnetically guiding sheet are provided as U-shaped;
or both the first magnetically guiding sheet and the second magnetically guiding sheet are provided as L-shaped.

5. The relay according to claim 1, wherein the elastic assembly comprises a first elastic member and a second elastic member, both the first elastic member and the second elastic member are compression springs, and both the first elastic member and the second elastic member are provided on a side of the movable contact plate away from the stationary contact.

6. The relay according to claim 1, wherein the elastic assembly comprises a first elastic member and a second elastic member, both the first elastic member and the second elastic member are tension springs, and both the first elastic member and the second elastic member are provided on a side of the movable contact plate facing the stationary contact.

7. The relay according to claim 1, wherein the elastic assembly comprises a first elastic member and a second elastic member, the first elastic member is a tension spring, the second elastic member is a compression spring, the first elastic member is provided on a side of the movable contact plate facing the stationary contact, and the second elastic member is provided on a side of the movable contact plate away from the stationary contact.

8. The relay according to claim 1, wherein the movable contact plate is provided with a through slot, the push rod is provided to pass through the through slot, and the movable contact plate slides with respect to the push rod.

9. The relay according to claim 1, wherein both sides of the movable contact plate are provided with a guiding plate respectively, and two guiding plates are spacing apart to form a guiding channel for the movable contact plate to slide.

10. The relay according to claim 5, wherein all elastic members are provided in a nested configuration in a same elastic assembly.

11. The relay according to claim 6, wherein all elastic members are provided in a nested configuration in a same elastic assembly.

12. The relay according to claim 5, wherein all elastic members are provided in parallel along a stretching direction in a same elastic assembly.

13. The relay according to claim 6, wherein all elastic members are provided in parallel along a stretching direction in a same elastic assembly.

14. The relay according to claim 7, wherein all elastic members are provided in parallel along a stretching direction in a same elastic assembly.

15. The relay according to claim 1, wherein all elastic members have a same elastic coefficient in a same elastic assembly.

16. The relay according to claim 1, wherein all elastic members have different elastic coefficients in a same elastic assembly.

17. The relay according to claim 16, wherein an elastic coefficient of the elastic member generating elastic force first is less than that of the elastic member generating elastic force later in a same elastic assembly.

18. The relay according to claim 16, wherein an elastic coefficient of the elastic member generating elastic force later is less than that of the elastic member generating elastic force first in a same elastic assembly.

19. The relay according to claim 1, wherein the electromagnetic assembly comprises a coil support, a coil, a fixed iron core, a yoke, and an armature, the coil is sheathed to an exterior of the fixed iron core, both the fixed iron core and the yoke are fixed to the coil support, the armature is fixedly connected to the push rod, the yoke and the fixed iron core generate a magnetic flux when the coil is energized, and the magnetic flux tends to form a closed magnetic loop to drive the armature to move close to the fixed iron core.
